(19) United States
(12) Patent Application Publication
(10) Pub. No.: US 2025/0357564 A1
(43) Pub. Date: Nov. 20, 2025

(54) ISOLATION FAULT DETECTION FOR ELECTRIC VEHICLE BATTERY ENCLOSURE

(71) Applicant: Rivian IP Holdings, LLC, Irvine, CA (US)

(72) Inventors: Youngbin LIM, Irvine, CA (US); Jonathan Christopher WILSON, Rancho Mission Viejo, CA (US); Baojin WANG, San Marcos, CA (US); Curtis Wesley CHAUVIN, Anaheim, CA (US); Adam Richard BALLARD, Corona, CA (US); Karteek PALLERLA, Irvine, CA (US)

(21) Appl. No.: 18/664,865

(22) Filed: May 15, 2024

(51) Int. Cl. H01M 10/48; H01M 10/613; H01M 10/6567; H01M 50/209

(52) U.S. Cl. CPC H01M 10/482; H01M 10/613; H01M 10/6567; H01M 50/209; H01M 2220/20

(57) ABSTRACT

Isolation fault detection for an electric vehicle (EV) battery enclosure is provided. Certain embodiments provide a battery enclosure that includes, inter alia, a housing, battery cells, and a conductive thread electrically coupled to at least one battery cell. The housing includes a first enclosure member and a second enclosure member. The conductive thread has a length, a dry resistance, and a wet resistance that is less than the dry resistance. The conductive thread extends away from the battery cell towards the second enclosure member. The length is less than a distance between the battery cell and the second enclosure member.

### INTRODUCTION

The present disclosure relates to electric vehicles (EVs). More particularly, the present disclosure relates to isolation fault detection for an electric vehicle battery enclosure.

### SUMMARY

Embodiments of the present disclosure advantageously provide isolation fault detection for an electric vehicle battery enclosure.

In certain embodiments, a battery enclosure includes, inter alia, a housing, battery cells, and a conductive thread electrically coupled to at least one battery cell. The housing includes a first enclosure member and a second enclosure member. The conductive thread has a length, a dry resistance, and a wet resistance that is less than the dry resistance. The conductive thread extends away from the battery cell towards the second enclosure member. The length is less than a distance between the battery cell and the second enclosure member.

### BRIEF DESCRIPTION OF THE DRAWINGS

FIG. 1 depicts a diagram of an example electric vehicle, in accordance with embodiments of the present disclosure.

FIG. 2 presents a block diagram of example components of an EV, in accordance with embodiments of the present disclosure.

FIG. 3 presents an exploded perspective view of an example battery enclosure, in accordance with embodiments of the present disclosure.

FIG. 4A presents a sectional view of a rear portion of the example battery enclosure depicted in FIG. 3, in accordance with embodiments of the present disclosure.

FIG. 4B presents a close-up of the sectional view depicted in FIG. 4A, in accordance with embodiments of the present disclosure.

FIG. 5A presents a sectional view of a front portion of the example battery enclosure depicted in FIG. 3, in accordance with embodiments of the present disclosure.

FIG. 5B presents a sectional view of the rear portion of the example battery enclosure depicted in FIG. 3, in accordance with embodiments of the present disclosure.

FIG. 6A presents a sectional view of the front portion of the example battery enclosure depicted in FIG. 3, in accordance with embodiments of the present disclosure.

FIG. 6B presents a circuit diagram of the example battery enclosure depicted in FIG. 3, in accordance with embodiments of the present disclosure.

### DETAILED DESCRIPTION

A battery enclosure for an electric vehicle protects the traction battery from exposure to water, dust, debris and other elements. The battery enclosure may include, inter alia, a housing that has a first enclosure member (such as a top cover, tray, tub, etc.) and a second enclosure member (such as a bottom cover, tray, tub, etc.), and a battery pack that has a number of battery cells. The battery pack is an important component of the EV's high voltage (HV) electrical system, and generates between 300 V and 900 V, such as 400 V, 800 V, etc. The HV electrical system also includes, inter alia, electric motors, motor control units (MCUs), power distribution units (PDUs), electric AC compressor, HV wiring harness, etc. A separate low voltage (LV) electrical system is powered by an LV battery that generates 12 V.

A frame may be attached to the housing to support the battery pack. In one example, the frame may be a separate component that is attached to the battery pack and the housing. The first enclosure member may be sealed to the second enclosure member, and the frame may include one or more longitudinal members that are located within the enclosed space within the housing. In another example, the frame may include transverse and longitudinal members that form a rectangular outer frame. The first enclosure member may be sealed to one surface of the frame (such as an upper surface, etc.), and the second enclosure member may be sealed to another surface of the frame (such as a lower surface, etc.). Other frame configurations are also supported. For example, the frame may be integrally formed with the first enclosure member or the second enclosure member, integrally formed with the battery pack, etc.

The housing of the battery enclosure is electrically coupled to the vehicle chassis, which provides the electrical ground (GND) for the LV electrical system. Generally, a short circuit is a low-resistance conductive path, and proper electrical isolation between the battery cells of the battery pack and the housing prevents a short circuit condition from arising between the battery pack (and the HV electrical system) and the electrical ground for the LV electrical system.

The battery enclosure may include a liquid cooling system to cool the battery pack. The liquid cooling system includes liquid coolant and one or more cooling plates, tubes, conduits, ducts, etc. that are located next to (or within) the battery pack to dissipate the heat generated by the battery cells during charging and discharging. The liquid cooling system is a closed system that isolates the liquid coolant from the battery cells.

When a significant amount of liquid accumulates within the battery enclosure (due to a coolant leak, water condensation, water intrusion, etc.), certain difficulties may be presented, such as short circuits, arcing, heat generation, hydrogen and oxygen gas production as a result of water electrolysis, housing corrosion, etc. An isolation fault occurs when the liquid creates a short circuit between the battery cells of the battery pack and the housing (which is coupled to the electrical ground for the LV electrical system through the vehicle chassis). While an isolation fault may be detected after the liquid fills the air space (also known as an air gap) between the battery cells of the battery pack and the housing, detecting the isolation fault after the short circuit has occurred may present difficulties.

Additionally, when the vehicle is driving (or parked) on an incline or a decline, the battery enclosure is tilted at an angle with respect to the horizontal plane. An angled orientation allows the liquid to collect not only in air spaces located at the front of the battery enclosure (due to a decline) or in air spaces located at the rear of the battery enclosure (due to an incline), but also under the battery cells at the front or rear of the battery pack. In these situations, even less liquid may be required to fill the air space between the battery cells of the battery pack and the housing to create a short circuit.

Embodiments of the present disclosure advantageously provide early detection of potential isolation faults caused by liquid accumulation within the battery enclosure before the liquid comes into contact with the battery cells of the battery pack.

In certain embodiments, a capillary thread (also known as a conductive thread) may be attached to one or more of the battery cells. The conductive thread extends away from the battery cell towards the housing. The conductive thread is nonconductive when dry, and conductive when wet. When the liquid rises to a certain height within the air space between the battery pack and the housing, the conductive thread becomes wet and forms a conductive path between the battery cell and the housing. This conductive path forms a short circuit between the battery cell, the housing, the vehicle chassis, and the electrical ground for the LV electrical system that may be detected by the electric vehicle's control system as, for example, a decrease in the isolation resistance (or impedance) of the HV electrical system.

The length of the conductive thread may determine the height of the liquid that may be detected. In other words, different lengths of conductive thread may detect different liquid heights. Additionally, the length, the cross-sectional area, and the type of material may determine the dry resistance and the wet resistance of the conductive thread.

In various embodiments, a conductive thread may be located where a high voltage potential exists with a small creepage distance between the battery cells of the battery pack and the housing. For example, a conductive thread may be attached to a battery cell at various locations within the battery enclosure, such as a peripheral location (e.g., a corner, a front end, a rear end, a side, etc.), a central location (e.g., the middle of the battery pack, etc.), etc.

In certain embodiments, the conductive thread may be a wholly conductive fiber, a core conductive fiber, a sandwich-type fiber, a coated yarn, a shell conductive fiber, or a combination of one or more of these fibers.

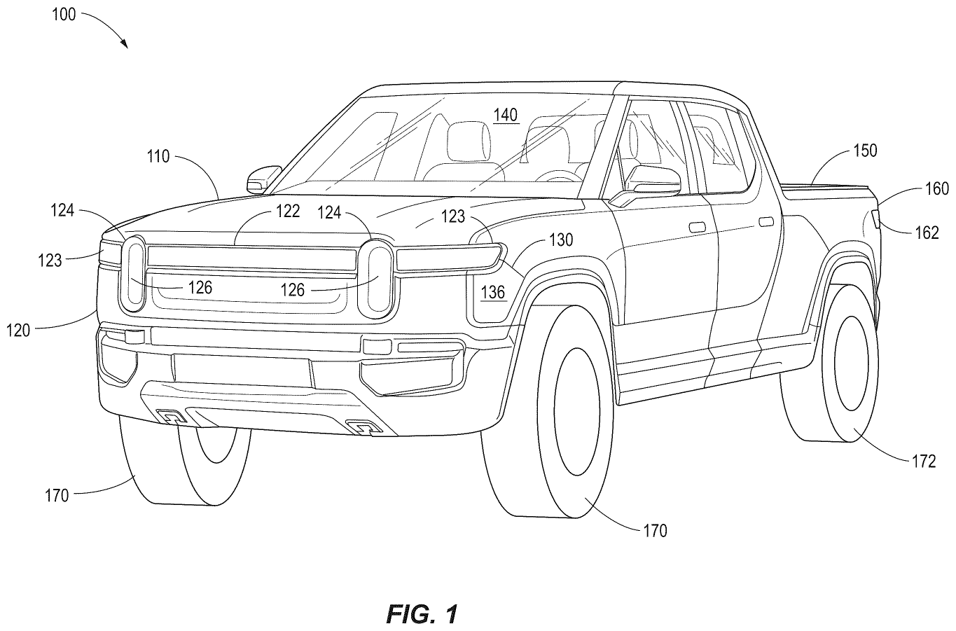

FIG. 1 depicts a diagram of an example electric vehicle 100, in accordance with embodiments of the present disclosure.

Electric vehicle 100 includes, inter alia, a frame and body 110, an electrical power storage and distribution system, a propulsion system, a suspension system, a steering system, a control system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light rings 124, headlights 126, charging port 130 with charging port cover 136 concealing charging connector socket, driver/passenger compartment or cabin 140, bed 150, rear end 160 with rear taillights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more electronic control units (ECUs), one or more electric drive unit (EDUs), front wheels 170, rear wheels 172, etc. The electrical power storage and distribution system may include, inter alia, one or more ECUs, a battery enclosure including a housing containing a traction battery, a vehicle charging subsystem including charging port 130, a high voltage (HV) wiring harness connecting the traction battery to the other HV electrical system components, such as the EDUs, etc.

A single motor EDU may be used to drive front wheels 170 (front wheel drive) or rear wheels 172 (rear wheel drive). Additionally, a single motor EDU may be used to drive front wheels 170 and a single motor EDU may be used to drive rear wheels 172 (four wheel drive). A dual motor EDU may be used to independently drive front wheels 170 (independent front wheel drive) or rear wheels 172 (independent rear wheel drive). Additionally a dual motor EDU may be used to independently drive both front wheels 170 and a dual motor EDU may be used to independently drive both rear wheels 172 (independent four wheel drive).

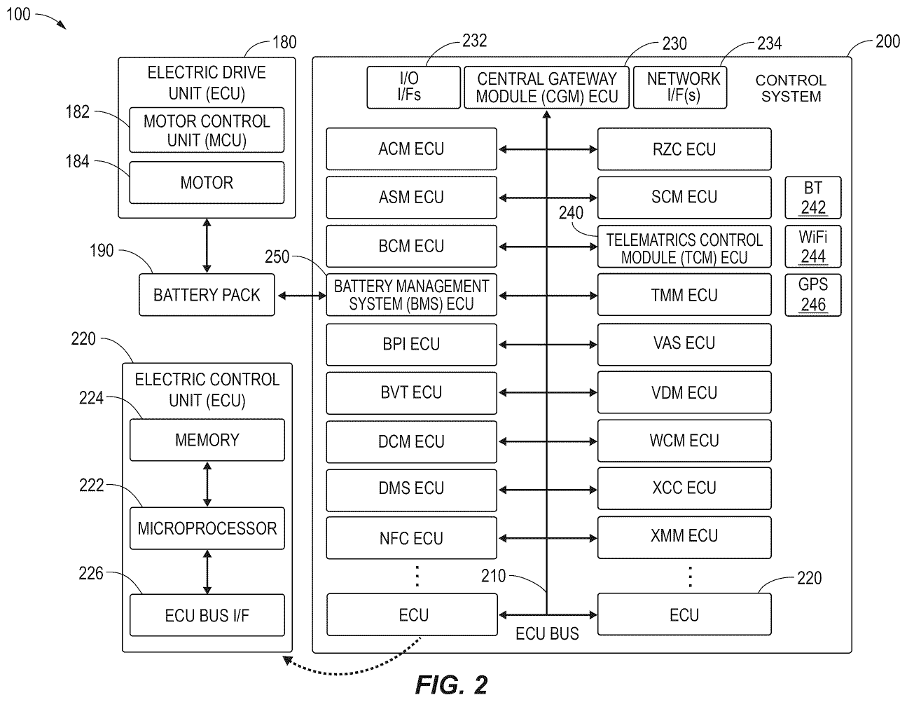

FIG. 2 presents a block diagram of example components of electric vehicle 100, in accordance with embodiments of the present disclosure.

Generally, electric vehicle 100 includes control system 200 that is configured to perform the functions necessary to operate electric vehicle 100. In certain embodiments, control system 200 includes a number of ECUs 220 coupled to ECU bus 210 (also known as a controller area network or CAN bus). Each ECU 220 performs a particular set of functions, and includes, inter alia, microprocessor 222 coupled to memory 224 and ECU bus interface (I/F) 226.

Microprocessor 222 may be a microcontroller unit, a microprocessing unit, a central processing unit (CPU), a programmable logic device (PLD), a complex PLD, a field programmable gate array (FPGA), an application specific integrated circuit (ASIC), etc. Memory 224 may include non-volatile and/or volatile memory, such as read only memory (ROM), random access memory (RAM), static RAM (SRAM), dynamic RAM (DRAM), flash memory, etc.

In certain embodiments, control system 200 may include a number of system-on-chips (SoCs). Each SoC may include a number of multi-core processors coupled to a high-speed interconnect and on-chip memory that provide more robust functionality and performance than a single ECU 220. Accordingly, each SoC may combine the functionality provided by several ECUs 220.

Control system 200 may be coupled to sensors (such as cameras, radar sensors, ultrasonic sensors, etc.), actuators (such as electric, hydraulic, pneumatic, etc.), input/output (I/O) devices, as well as other components within the propulsion system, the electrical power storage and distribution system, the suspension system, the steering system, the auxiliary and accessory systems, etc., such as EDU 180, battery pack 190, etc.

Control system 200 may include central gateway module (CGM) ECU 230, which provides a central communications hub for electric vehicle 100. CGM ECU 230 includes (or is coupled to) I/O I/F(s) 232 to receive data from, and send commands to, various vehicle components, such as sensors, actuators, input devices, output devices, etc. CGM ECU 230 also includes (or is coupled to) network I/F(s) 234 to provide network connectivity through ECU bus ports, local interconnect network (LIN) ports, Ethernet ports, etc.

CGM ECU 230 may route messages (including commands, data, etc.) over ECU bus 210 from one ECU 220 to another ECU 220, or from one ECU 220 to multiple ECUs 220 (such as broadcast messages, etc.). In one example, CGM ECU 230 may receive a message from a source ECU 220, process the message to determine, inter alia, the destination ECU 220, and then transmit the message to the destination ECU 220. In another example, CGM ECU 230 may simply arbitrate ECU bus 210 to allow the source ECU 220 to send a message directly to the destination ECU 220.

CGM ECU 230 may receive data from a sensor, an I/O device, a vehicle component, etc., and then send a message containing the data to the appropriate ECU 220 over ECU bus 210. Similarly, CGM ECU 230 may receive a message containing a command or data from a source ECU 220, and then send the command or the data to the appropriate actuator, I/O device, vehicle component, etc. Additionally, CGM ECU 230 may manage the vehicle mode (such as road driving mode, off-roading mode, tow mode, camping mode, parked mode, etc.), and may control certain vehicle components related to transitioning from one vehicle mode to another vehicle mode.

Control system 200 may include telematics control module (TCM) ECU 240 which provides a wireless communications hub for electric vehicle 100. TCM ECU 240 may include or may be coupled to Bluetooth (BT) or Bluetooth Low Energy (BLE) transceiver 242, WiFi transceiver 244, global positioning system (GPS) receiver 246, etc.

Control system 200 may include battery management system (BMS) ECU 250 to manage the charging of battery pack 190, as well as to perform other related tasks, such as isolation fault detection, etc. BMS ECU 250 may be coupled to the HV wiring harness to measure the isolation resistance (or impedance) of the HV electrical system, and may also include the necessary interfaces to be coupled directly to battery pack 190.

In certain embodiments, control system 200 may also include, inter alia, autonomy control module (ACM) ECU, autonomous safety module (ASM) ECU, body control module (BCM) ECU, battery power isolation (BPI) ECU, balancing voltage temperature (BVT) ECU, door control module (DCM) ECU, driver monitoring system (DMS) ECU, near-field communication (NFC) ECU, rear zone control (RZC) ECU, seat control module (SCM) ECU, thermal management module (TMM) ECU, vehicle access system (VAS) ECU, winch control module (WCM) ECU, motor control unit (XCC) ECU, experience management module (XMM) ECU, etc.

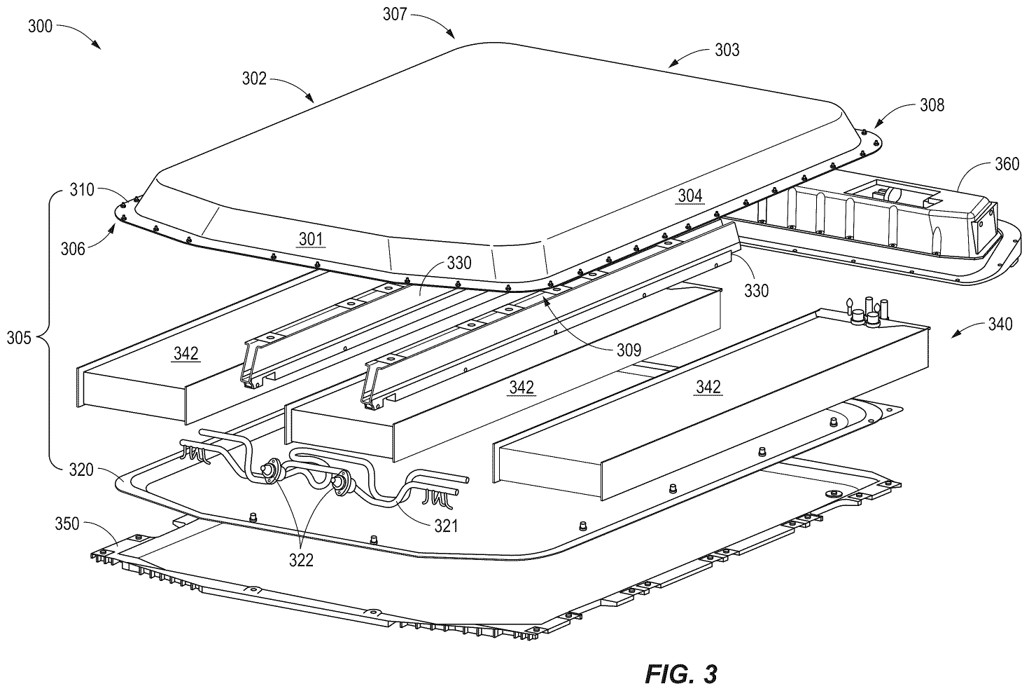

FIG. 3 presents an exploded perspective view of battery enclosure 300, in accordance with embodiments of the present disclosure. As discussed above, battery enclosure 300 may be configured in different ways. Certain example embodiments of battery enclosure 300 are depicted in FIGS. 3 to 6B and described below.

In certain embodiments, battery enclosure 300 includes, inter alia, housing 305, frame 330, battery pack 340 (described as battery pack 190 above), lower plate 350, and electronics enclosure 360. Housing 305 includes top cover 310 and bottom tray 320 (as depicted in FIG. 3). Top cover 310 is attached to bottom tray 320, frame 330 is attached to top cover 310 and/or bottom tray 320, battery pack 340 is attached to frame 330, and lower plate 350 is attached to bottom tray 320. These components may be attached using fasteners, such as screws, bolts and nuts, rivets, snap-fit clips, pins, etc. Battery enclosure 300 has a generally rectangular shape, with front side 301, right side 302, rear side 303, and left side 304, as well as front-right corner 306, rear-right corner 307, rear-left corner 308 and front-left corner 309. Battery enclosure 300 may also have other shapes, such as a square shape, a triangular shape, an oval shape, a hexagonal shape, etc.

In some embodiments, top cover 310 may be a cold stamped steel deep drawn cover, while bottom tray 320 may be a hot stamped steel tray. Other metal forming (or forging) techniques may also be used. A scaling material may be disposed between top cover 310 and bottom tray 320 to provide a continuous seal along the periphery of battery enclosure 300. The scaling material may protect against water intrusion, thermal runaway, etc.

A liquid cooling plate may be attached to, or integrally formed with, bottom tray 320. Coolant manifold 321 may be attached to bottom tray 320 and may be fluidically coupled to the liquid cooling plate, while coolant inlet couplings 322 may be attached to top cover 310 and may be fluidically coupled to coolant manifold 321. In certain embodiments, coolant manifold 321 may be fluidically coupled to liquid cooling plates, tubes, conduits, ducts, etc. that are located within battery pack 340 or attached to one or more external surfaces of battery pack 340.

Frame 330 may include two longitudinal steel members that are located within the enclosed space formed by top cover 310 and bottom tray 320 (as depicted in FIG. 3).

Battery pack 340 includes a number of battery cells, such as cylindrical cells, prismatic cells, pouch cells, etc. In certain embodiments, battery pack 340 may include three battery modules 342 (as depicted in FIG. 3), and each battery module 342 may include a number of battery cells. Generally, the battery cells are coupled to a positive busbar and a negative busbar within each battery module 342. The positive busbar of each battery module 342 is connected to an HV positive battery terminal of battery enclosure 300, the negative busbar of each battery module 342 is connected to an HV negative battery terminal of battery enclosure 300, and an HV wiring harness is connected to the HV positive battery terminal and the HV negative battery terminal of battery enclosure 300.

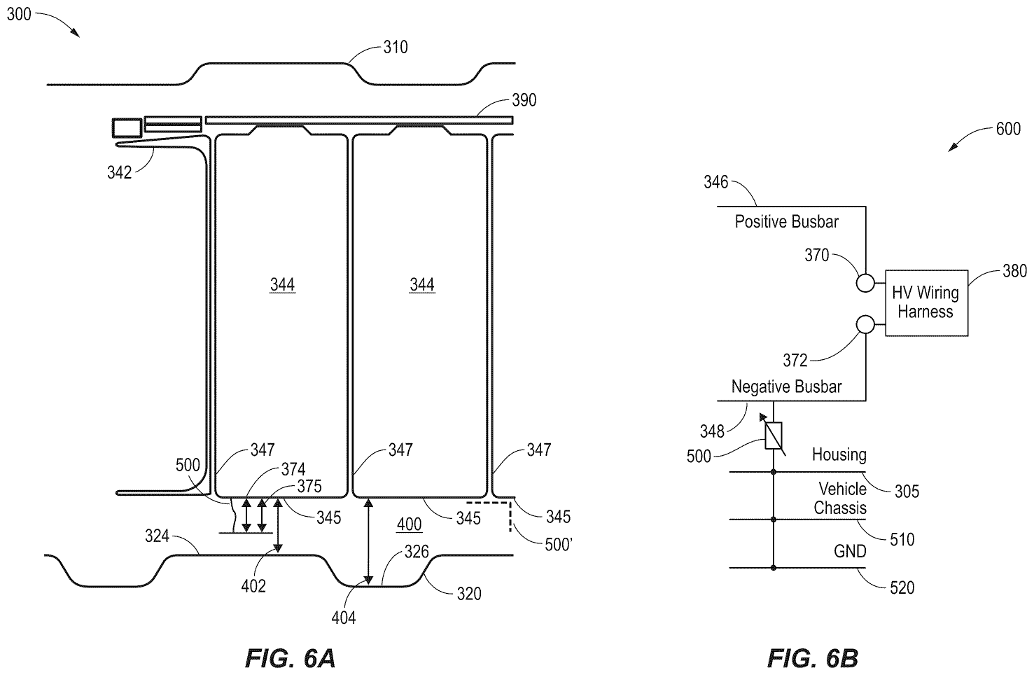

In the example depicted in FIG. 6B, positive busbar 346 is connected to HV positive battery terminal 370 of battery enclosure 300, negative busbar 348 is connected to HV negative battery terminal 372 of battery enclosure 300, and HV wiring harness 380 is coupled to HV positive battery terminal 370 and HV negative battery terminal 372 of battery enclosure 300.

In certain embodiments, each battery module 342 includes cylindrical battery cells that have two sides and a cell housing. One side has a circular shape, a positive terminal located in the center, and a negative terminal located along the perimeter (such as the top side or the bottom side). The cell housing has a cylindrical shape that is electrically coupled to the negative terminal. The other side has a circular shape that is electrically coupled to the cell housing (such as the bottom side or the top side). The battery cells may be connected to a current collector assembly (CCA) that includes the positive busbar and the negative busbar. The CCA has a single-sided cell interconnection architecture that includes positive tabs that are connected to the positive terminals of the battery cells, and negative tabs that are connected to the negative terminals of the battery cells. The positive tabs are connected to the positive busbar of the CCA, while the negative tabs are connected to the negative busbar of the CCA.

Lower plate 350 may be formed from a composite material, a lightweight metal or metal alloy, etc. Generally, lower plate 350 protects bottom tray 320 from road or road debris damage.

Similarly, electronics enclosure 360 may be formed from a composite material, a lightweight metal or metal alloy, etc. Electronics enclosure 360 may be mounted on top cover 310, and may contain certain electrical power system components, such as an energy management module (EMM), a high voltage distribution box (HVDB), etc., that are coupled to battery pack 340.

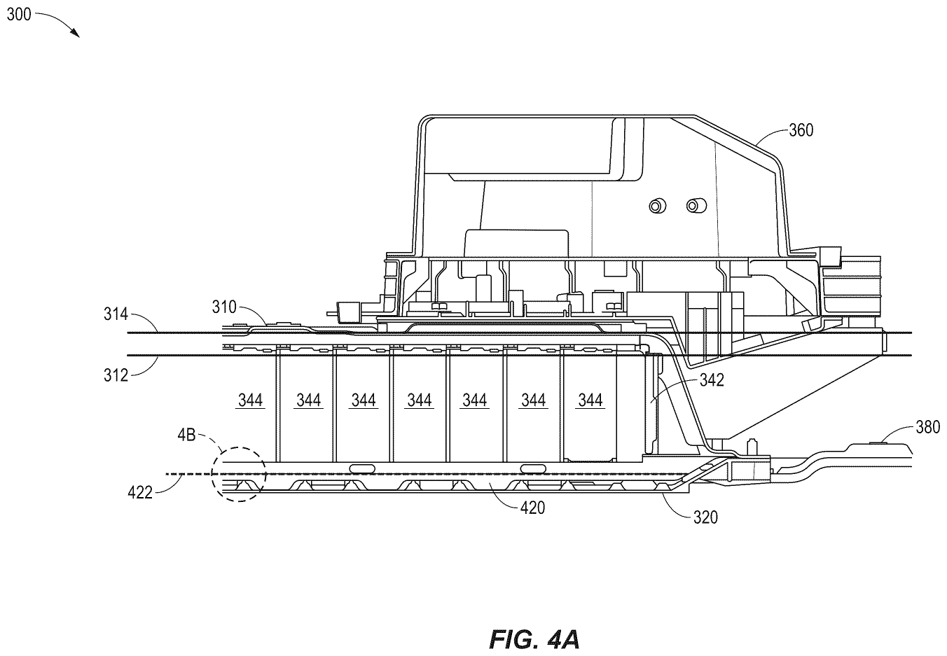

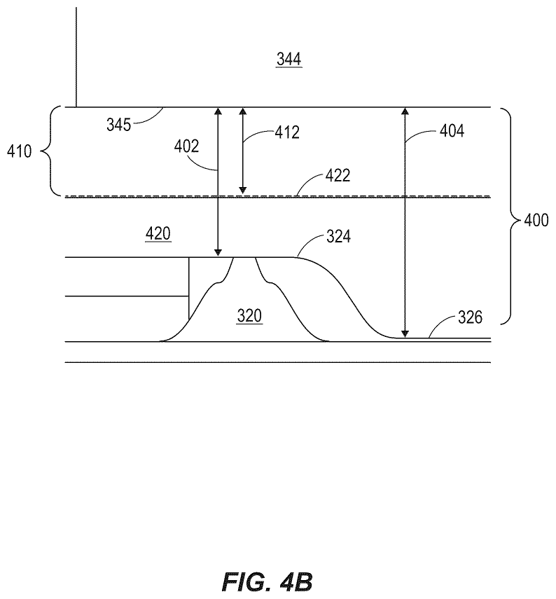

FIG. 4A presents a sectional view of a rear portion of battery enclosure 300, in accordance with embodiments of the present disclosure.

Top cover 310, bottom tray 320, battery module 342, battery cells 344, electronics enclosure 360, and HV wiring harness 380 are identified.

Reference plane 314 establishes an orientation for battery enclosure 300 relative to horizontal plane 312, which is parallel to the Earth's surface at the location of electric vehicle 100. In a horizontal orientation, reference plane 314 is parallel to horizontal plane 312.

To illustrate certain aspects of the present disclosure, battery enclosure 300 is depicted in a horizontal orientation after a volume of liquid coolant 420 has leaked from the liquid coolant system into the space between battery cells 344 and bottom tray 320. In this example, all of the liquid coolant 420 has leaked from the liquid coolant system into battery enclosure 300 (a portion of which is depicted in FIG. 4A). In other words, the volume of liquid coolant 420 is disposed outside of the liquid cooling system and inside housing 305.

Due to the horizontal orientation of battery enclosure 300, liquid coolant surface 422 is parallel to horizontal plane 312, the lower surface of battery cells 344, and the upper surface of bottom tray 320.

FIG. 4B presents a close-up of the sectional view depicted in FIG. 4A, in accordance with embodiments of the present disclosure.

Space 400 is located between battery cells 344 and bottom tray 320. Space 400 includes air space 410 and liquid coolant 420. The distance between lower surface 345 of battery cell 344 and upper surface 324 of bottom tray 320 is represented by distance 402, while the distance between lower surface 345 of battery cell 344 and lower surface 326 of bottom tray 320 is represented by distance 404. The distance between lower surface 345 of battery cell 344 and liquid coolant surface 422 is represented by remaining distance 412. Because remaining distance 412 is greater than zero, liquid coolant surface 422 does not contact lower surface 345 of battery cell 344, and a short circuit condition is not present between battery cell 344 and bottom tray 320 of housing 305.

When the remaining distance 412 is reduced to zero, liquid coolant surface 422 contacts lower surface 345 of battery cell 344, which creates a short circuit condition between battery cell 344 and bottom tray 320 of housing 305 due to the conduction of electricity by liquid coolant 420. This condition may occur when battery enclosure 300 is tilted at an angle with respect to horizontal plane 312, such as a pitch angle, a roll angle, or a combination of a pitch angle and a roll angle.

For example, when driving or parking on an incline, electric vehicle 100 has a positive pitch angle with respect to horizontal plane 312, and when driving or parking on a decline, electric vehicle 100 has a negative pitch angle with respect to horizontal plane 312. Similarly, when tilted to one side or the other side, electric vehicle 100 has a positive or negative roll angle with respect to horizontal plane 312. Generally, when a fluid (such as liquid coolant 420, water, etc.) has accumulated between battery cells 344 and bottom tray 320 of housing 305, a pitch angle, a roll angle, or a combination of a pitch angle and a roll angle may create a short circuit condition between battery cell 344 and bottom tray 320 of housing 305. In one example, the pitch angle may be between −45° and −5° (such as −30°, −25°, −22°, −20°, −15°, etc.) or between 5° and 45° (such as 30°, 25°, 22°, 20°, 15°, etc.). Similarly, in another example, the roll angle may be between −45° and −5° (such as −30°, −25°, −22°, −20°, −15°, etc.) or between 5° and 45° (such as 30°, 25°, 22°, 20°, 15°, etc.).

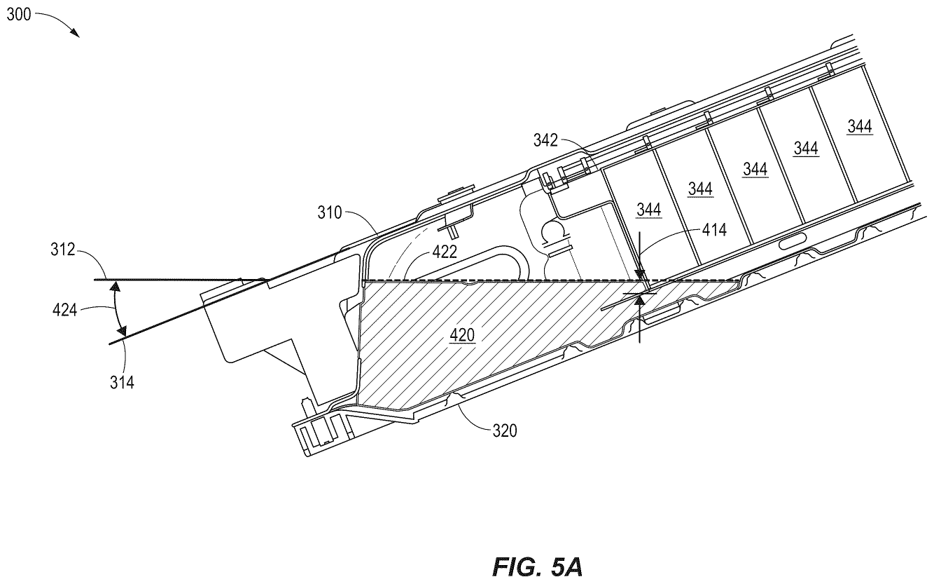

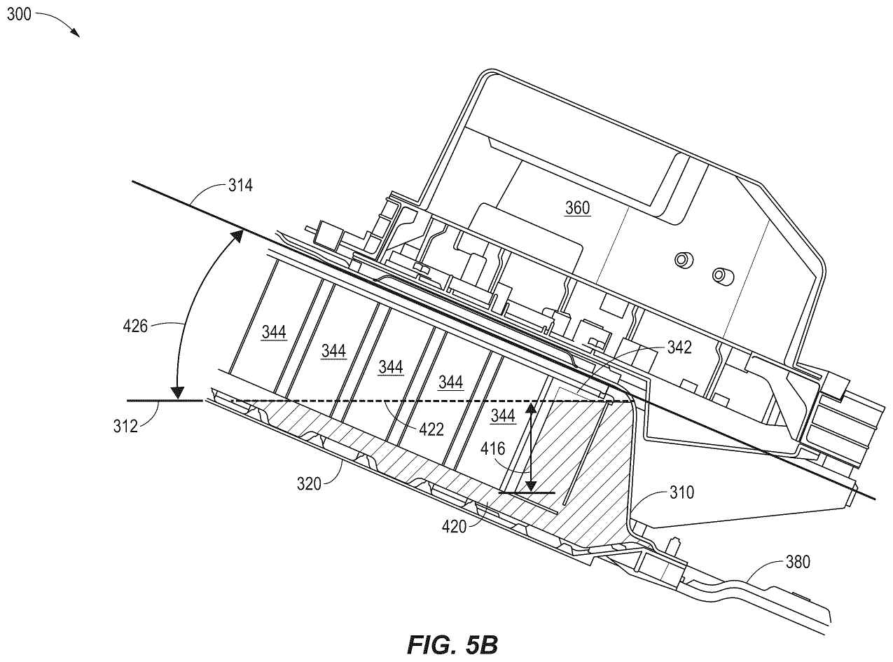

FIG. 5A presents a sectional view of a front portion of battery enclosure 300, in accordance with embodiments of the present disclosure.

Top cover 310, bottom tray 320, battery module 342, battery cells 344, horizontal plane 312, and reference plane 314 are identified.

To illustrate certain aspects of the present disclosure, battery enclosure 300 is depicted in a tilted orientation after the volume of liquid coolant 420 has leaked from the liquid coolant system into the space between battery cells 344 and bottom tray 320. In this example, the pitch angle 424 between horizontal plane 312 and reference plane 314 is about −22°.

Due to the negative pitch angle, the volume of liquid coolant 420 has collected in the spaces at the front of battery enclosure 300. Liquid coolant surface 422 is parallel to horizontal plane 312, and contacts the front battery cell 344 in each battery module 342 of battery pack 340. More particularly, liquid coolant surface 422 contacts a portion of the lower side and/or a portion of the cell housing of the front battery cell 344 in each battery module 342 of battery pack 340. In one example battery enclosure 300, the volume of liquid coolant 420 is about 15 liters and extends about 7 mm above the lowest portion of each front battery cell 344, as indicated by liquid coolant distance 414.

Generally, when the volume of liquid coolant 420 has collected in the spaces at the front of battery enclosure 300, liquid coolant surface 422 may contact a lower portion of the front battery cell 344 in each battery module 342 of battery pack 340 at a predetermined pitch angle, such as −5°, −10°, −15°, −20°, −25°, −30°, −35°, −40°, −45°, etc.

FIG. 5B presents a sectional view of the rear portion of battery enclosure 300, in accordance with embodiments of the present disclosure.

Top cover 310, bottom tray 320, battery module 342, battery cells 344, electronics enclosure 360, HV wiring harness 380, horizontal plane 312, and reference plane 314 are identified.

To illustrate certain aspects of the present disclosure, battery enclosure 300 is depicted in a tilted orientation after the volume of liquid coolant 420 has leaked from the liquid coolant system into the space between battery cells 344 and bottom tray 320. In this example, the pitch angle 424 between horizontal plane 312 and reference plane 314 is about +22°.

Due to the positive pitch angle, the volume of liquid coolant 420 has collected in the spaces at the rear of battery enclosure 300. Liquid coolant surface 422 is parallel to horizontal plane 312, and contacts several rear battery cells 344 in each battery module 342 of battery pack 340. More particularly, liquid coolant surface 422 contacts a portion of the lower side and/or a portion of the cell housing of several rear battery cells 344 in each battery module 342 of battery pack 340. In one example battery enclosure 300, the volume of liquid coolant 420 is about 15 liters and extends about 75 mm above the lowest portion of the rear-most battery cell 344, as indicated by liquid coolant distance 416.

Generally, when the volume of liquid coolant 420 has collected in the spaces at the rear of battery enclosure 300, liquid coolant 420 may contact a lower portion of the rear battery cell 344 in each battery module 342 of battery pack 340 at a predetermined pitch angle, such as 5°, 10°, 15°, 20°, 25°, 30°, 35°, 40°, 45°, etc.

FIG. 6A presents a sectional view of the front portion of battery enclosure 300, in accordance with embodiments of the present disclosure.

Top cover 310, bottom tray 320, battery module 342, battery cells 344, and CCA 390 are identified.

Space 400 is located between battery cells 344 and bottom tray 320, as described with respect to FIG. 4B. The distance between lower surfaces 345 of battery cells 344 and upper surface 324 of bottom tray 320 is represented by distance 402, and the distance between lower surfaces 345 of battery cells 344 and lower surface 326 of bottom tray 320 is represented by distance 404. Because bottom tray 320 is not flat, distance 404 is larger than distance 402. In other examples, bottom tray 320 may be flat, and distance 402 and distance 404 may be the same.

Conductive thread 500 is electrically coupled to the lower portion of one of the battery cells 344 (such as lower surface 345 and/or the lower portion of battery cell housing 347), and extends away from the battery cell 344 towards bottom tray 320. Conductive thread 500 has overall length 374, length 375 (also known as the measurement length), a cross-sectional area, a dry resistance, and a wet resistance. The dry resistance and the wet resistance may be based on length 375, the cross-sectional area, and the type of conductive thread material. Generally, the magnitude of the dry resistance prevents a short circuit condition from developing between battery cell 344 and bottom tray 320 (even when conductive thread 500 is not in physical contact with housing 305, such as during an arcing condition, etc.). The magnitude of the wet resistance is less than the magnitude of the dry resistance, and allows a short circuit condition to develop between battery cell 344 and bottom tray 320 of housing 305 when liquid fills space 400 and wets conductive thread 500. In some embodiments, the dry resistance may be greater than 2 Gigaohms (GΩ), while the wet resistance may be less than 0.4 Megaohms (MΩ), such as 0.1 MΩ, 0.2 MΩ, etc.

In certain embodiments, conductive thread 500 may be electrically coupled to the lower portion of two adjacent battery cells 344 (such as lower surfaces 345 and/or the lower portions of battery cell housings 347), and extends away from the battery cells 344 towards bottom tray 320 (as depicted by conductive thread 500′). In other embodiments, conductive thread 500 may be electrically coupled to the lower portion of three (or more) adjacent battery cells 344 (such as lower surfaces 345 and/or the lower portions of battery cell housings 347). In other words, conductive thread 500 is electrically coupled to at least one battery cell 344.

More particularly, after a lower portion of conductive thread 500 is immersed in a liquid that has accumulated in space 400 (such as liquid coolant 420, water, etc.), conductive thread 500 wicks the liquid along its length 375, thereby converting the magnitude of the resistance from the dry resistance value to the wet resistance value. Once wet, conductive thread 500 forms a conductive path between the negative terminal of battery cell 344 and bottom tray 320 of housing 305, the vehicle chassis, and the electrical ground for the LV electrical system. The short circuit condition may be detected by BMS ECU 250 as a decrease in the isolation resistance (or impedance) of the HV electrical system.

Advantageously, early detection of potential isolation faults before liquid comes into contact with battery cells 344 allows control system 200 to mitigate or prevent damage to battery pack 340, battery enclosure 300, and electric vehicle 100.

In certain embodiments, battery cells 344 are cylindrical battery cells (as described above), and conductive thread 500 may be electrically coupled to the cell housing or lower surface 345 of the battery cell 344 at the front of battery module 342, as depicted in FIG. 6A. In some embodiments, conductive thread 500 may be electrically coupled to upper surface 324 of the battery cell 344). This conductive thread 500 may be used to detect the accumulation of liquid in battery enclosure 300 when electric vehicle 100 has a negative pitch angle. Another conductive thread 500 may be attached to the cylindrical housing or lower surface 345 of one of the battery cells 344 in the rear of battery module 342. This conductive thread 500 may be used to detect the accumulation of liquid in battery enclosure 300 when electric vehicle 100 has a positive pitch angle. Similarly, conductive threads 500 may be electrically coupled to battery cells 344 within other battery modules 342.

Generally, a conductive thread 500 may be attached to a battery cell 344 where a high voltage potential exists with a small creepage distance between the battery cell 344 and housing 305. For example, conductive thread 500 may be attached to battery cells 344 that are located proximate to one or more peripheral locations of housing 305, such as front side 301, right side 302, rear side 303, left side 304, front-right corner 306, rear-right corner 307, rear-left corner 308, front-left corner 309, etc.

The length of conductive thread 500 may determine the height of the liquid above upper surface 324 that may be detected for a particular distance 402. In other words, different lengths of conductive thread 500 may detect different liquid heights above upper surface 324 of bottom tray 320. In certain embodiments, length 375 may be 8 mm, 10 mm, 15 mm, 20 mm, 25 mm, 30 mm, etc., distance 402 may be 15 mm, 20 mm, 25 mm, 30 mm, 40 mm, etc., and the detected height above upper surface 324 may be 5 mm, 10 mm, etc. For example, for a distance 402 of 10 mm, a length 375 of 10 mm may be used to detect a height of 5 mm to 15 mm above upper surface 324. In one example, overall length 374 may be 10.2 mm, and length 375 may be 10 mm. The 0.2 mm difference between overall length 374 and length 375 is the portion of conductive thread 500 that is electrically coupled to the lower portion of battery cell 344 using a conductive adhesive, conductive tape, etc.

FIG. 6B presents a circuit diagram 600 of battery enclosure 300, in accordance with embodiments of the present disclosure.

Positive busbar 346 of CCA 390 is connected to HV positive battery terminal 370 of battery enclosure 300. Negative busbar 348 of CCA 390 is connected to HV negative battery terminal 372 of battery enclosure 300. HV wiring harness 380 is coupled to HV positive battery terminal 370 and HV negative battery terminal 372 of battery enclosure 300.

Conductive thread 500 is represented as a variable resistor, which has a dry resistance value when dry and a wet resistance value when wet, as described above. Conductive thread 500 is electrically coupled to negative busbar 348 through the negative terminals of battery cells 344 and CCA 390, and to vehicle chassis 510 through bottom tray 320 of housing 305. Vehicle chassis 510 is electrically coupled to LV electrical ground 520, as described above.

In certain embodiments, BMS ECU 250 is coupled to HV wiring harness 380. BMS ECU 250 may be configured to manage certain functions related to battery pack 340, such as battery charging (e.g., DC fast charging), battery discharging, fault detection and notification, etc.

For example, BMS ECU 250 may be configured to monitor the isolation resistance (or impedance) of the HV electrical system using a high input impedance circuit electrically coupled to HV wiring harness 380 and LV electrical ground 520. When the isolation resistance falls below a first threshold value, such as 0.5 MΩ, etc., BMS ECU 250 may generate an isolation fault warning notification for presentation to an operator of electric vehicle 100 through a display. The isolation fault warning notification may be transmitted to another ECU over ECU bus 210, such as the XMM ECU, etc. When the isolation resistance falls below a second threshold value, such as 0.1 MΩ, 0.2 MΩ, 0.3 MΩ, etc., BMS ECU 250 may disable DC fast charging until the isolation resistance rises above a third threshold value, such as 0.5 MΩ, 1.0 MΩ, 1.5 MΩ, etc.

BMS ECU 250 may detect a positive isolation fault or a negative isolation fault depending on the attachment location of conductive thread 500 to the battery cell 344. For example, conductive thread 500 may be attached to the battery cell 344 at a high location (such as close to the positive terminal of the battery cell 344), a middle location (such as midway between the positive and negative terminals of the battery cell 344), a low location (such as close to the negative terminal of the battery cell 344), etc. A positive isolation fault may be detected when the attachment location is close to the positive terminal of battery cell 344, a negative isolation fault may be detected when the attachment location is close to the negative terminal of battery cell 344, etc.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A battery enclosure, comprising:
a housing including a first enclosure member and a second enclosure member;
battery cells; and
a conductive thread electrically coupled to at least one battery cell, the conductive thread having a length, a dry resistance, and a wet resistance that is less than the dry resistance,
wherein:
the conductive thread extends away from the at least one battery cell towards the second enclosure member, and
the length is less than a distance between the at least one battery cell and the second enclosure member.

2. The battery enclosure of claim 1, further comprising:
a frame attached to the housing and configured to support the battery cells,
wherein the frame separates the battery cells from the second enclosure member by the distance.

3. The battery enclosure of claim 1, wherein:
each battery cell includes:
a first side that has a positive terminal coupled to a positive busbar, and a negative terminal coupled to a negative busbar,
a cell housing that is electrically coupled to the negative terminal, and
a second side that is electrically coupled to the cell housing; and
the conductive thread is electrically coupled to the cell housing or the second side of the at least one battery cell.

4. The battery enclosure of claim 3, wherein:
the first side has a circular shape, the cell housing has a cylindrical shape, and the second side has a circular shape; and
the positive terminal is located in a center of the first side, and the negative terminal is located along a perimeter of the first side.

5. The battery enclosure of claim 3, wherein the at least one battery cell is located proximate to a peripheral location of the housing.

6. The battery enclosure of claim 3, wherein:
the housing has a plurality of peripheral locations; and
a conductive thread is electrically coupled to the cell housing or the second side of a battery cell that is located proximate to each of the peripheral locations of the housing.

7. The battery enclosure of claim 6, wherein:
the housing has a front portion and a rear portion; and
the peripheral locations are located within the front portion and the rear portion of the housing.

8. The battery enclosure of claim 6, wherein:
the housing has a first side portion and a second side portion; and
the peripheral locations are located within the first side portion and the second side portion of the housing.

9. The battery enclosure of claim 6, wherein:
the housing has a rectangular shape having corners; and
the peripheral locations are the corners of the housing.

10. The battery enclosure of claim 3, further comprising:
a liquid cooling system including a volume of liquid coolant,
wherein:
when the volume of liquid coolant is disposed outside of the liquid cooling system and inside the housing, the liquid coolant forms a liquid coolant surface that has a height above the second enclosure member, and
the height is less than the distance.

11. The battery enclosure of claim 10, wherein:
when the housing is disposed in a horizontal plane and the volume of liquid coolant is disposed outside of the liquid cooling system and inside the housing, the conductive thread contacts the liquid coolant surface and has the wet resistance.

12. The battery enclosure of claim 10, wherein:
when the housing is disposed at an angle to a horizontal plane and at least a portion of the volume of liquid coolant is disposed outside of the liquid cooling system and inside the housing, the conductive thread contacts the liquid coolant surface and has the wet resistance; and
the angle is between −45° and −5° or between 5° and 45°.

13. The battery enclosure of claim 10, wherein:
the positive busbar is coupled to a positive battery terminal;
the negative busbar is coupled to a negative battery terminal;
the second enclosure member is coupled to an electrical ground; and
when the conductive thread contacts the liquid coolant surface, a conductive path is formed between the negative battery terminal and the electrical ground by the conductive thread.

14. An electric vehicle, comprising:
the battery enclosure of claim 13; and
a battery management system (BMS) coupled to the positive battery terminal and the negative battery terminal, the BMS configured to detect an isolation fault when the conductive path is formed between the negative battery terminal and the electrical ground by the conductive thread.

15. A method for isolation fault detection for an electric vehicle, comprising:
providing a battery enclosure, including:
a housing including a first enclosure member and a second enclosure member, battery cells, and
a conductive thread electrically coupled to at least one battery cell, the conductive thread having a length, a dry resistance, and a wet resistance that is less than the dry resistance, wherein the conductive thread extends away from the at least one battery cell towards the second enclosure member, and the length is less than a distance between the at least one battery cell and the second enclosure member; and
when a liquid accumulates between the battery cells and the housing and wets the conductive thread:
determining, at an electronic control unit (ECU), that an isolation resistance between the battery cells and a low voltage electrical ground is less than a first threshold value, and
generating, at the ECU, an isolation fault notification for presentation to an operator of the electric vehicle on a display.

16. The method of claim 15, comprising:
determining, at the ECU, that the isolation resistance between the battery cells and the low voltage electrical ground is less than a second threshold value, the second threshold value being less than the first threshold value, and
disabling, at the ECU, a DC fast charging function.

17. The method of claim 16, comprising:
determining, at the ECU, that the isolation resistance between the battery cells and the low voltage electrical ground is greater than a third threshold value, the third threshold value being greater than the first threshold value, and
enabling, at the ECU, the DC fast charging function.

18. The method of claim 17, wherein the first threshold value is between 0.2 Megaohms and 0.5 Megaohms, the second threshold value is less than 0.2 Megaohms, and the third threshold value is greater than 1.0 Megaohms.

19. An electric vehicle, comprising:
a battery enclosure, including:
a housing coupled to an electrical ground,
battery cells electrically coupled to a first battery terminal and a second battery terminal, and
a conductive thread electrically coupled to at least one battery cell, the conductive thread having a length, a dry resistance, and a wet resistance that is less than the dry resistance, wherein the conductive thread extends away from the at least one battery cell towards the housing, and the length is less than a distance between the at least one battery cell and the housing; and
a battery management system (BMS) coupled to the first battery terminal and the second battery terminal, the BMS configured to detect an isolation fault when the conductive thread forms a conductive path between the at least one battery cell and the electrical ground.

20. The electric vehicle of claim 19, wherein the first battery terminal is a positive battery terminal, the second battery terminal is a negative battery terminal, and the conductive path is formed between the negative battery terminal and the electrical ground when the conductive thread contacts a liquid disposed between the at least one battery cell and the housing.
